(19) United States
(12) Patent Application Publication
(10) Pub. No.: US 2023/0189127 A1
(43) Pub. Date: Jun. 15, 2023

(54) SELECTIVE MANUAL PUBLIC LAND MOBILE NETWORK SCANNING

(71) Applicant: QUALCOMM Incorporated, San Diego, CA (US)

(72) Inventors: Ansah Ahmed SHEIK, Hyderabad (IN); Sayak SAHA, Hyderabad (IN)

(21) Appl. No.: 17/644,198

(22) Filed: Dec. 14, 2021

(51) Int. Cl. H04W 48/16; H04W 24/10

(52) U.S. Cl. CPC H04W 48/16; H04W 24/10; H04W 84/042

(57) ABSTRACT

Various aspects of the present disclosure generally relate to wireless communication. In some aspects, a user equipment (UE) may determine at least one of: the UE is not camped on a millimeter wave (mmW) cell and no neighboring cells are mmW cells, or the UE is operating in a mobility state. The UE may forgo, based on the determination, a manual public land mobile network (MPLMN) scan of mmW frequency bands. The UE may perform, based on the determination, an MPLMN scan of only non-mmW frequency bands for non-mmW cells. Numerous other aspects are described.

### FIELD OF THE DISCLOSURE

Aspects of the present disclosure generally relate to wireless communication and to techniques and apparatuses for selective manual public land mobile network scanning.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include determining at least one of: the UE is not camped on a millimeter wave (mmW) cell and no neighboring cells are mmW cells, or the UE is operating in a mobility state. The method may include forgoing, based on the determination, a manual public land mobile network (manual PLMN, or MPLMN) scan of mmW frequency bands. The method may include performing, based on the determination, an MPLMN scan of only non-mmW frequency bands for non-mmW cells.

Some aspects described herein relate to a method of wireless communication performed by a UE. The method may include performing an MPLMN scan of non-mmW frequency bands for non-mmW cells. The method may include determining, based at least in part on performing the MPLMN scan, that no non-mmW cells were identified by the MPLMN scan. The method may include forgoing a second MPLMN scan of mmW frequency bands for mmW cells based at least in part on the determination.

Some aspects described herein relate to a method of wireless communication performed by a UE. The method may include performing an MPLMN scan of non-mmW frequency bands for non-mmW cells. The method may include identifying, based at least in part on performing the MPLMN scan, at least one non-mmW cell. The method may include continuing the MPLMN scan for one or more mmW cells that correspond to the at least one non-mmW cell.

Some aspects described herein relate to a method of wireless communication performed by a UE. The method may include performing an MPLMN scan of a first set of frequency bands based at least in part on a user preference, the first set of frequency bands comprising one of: non-mmW frequency bands, or mmW frequency bands. The method may include providing data indicating a result of the MPLMN scan. The method may include selectively continuing the MPLMN scan, for a second set of frequency bands, based at least in part on one of: the user preference, or user input associated with the result of the MPLMN scan.

Some aspects described herein relate to a UE for wireless communication. The UE may include a memory and one or more processors coupled to the memory. The one or more processors may be configured to determine at least one of: the UE is not camped on a mmW cell and no neighboring cells are mmW cells, or the UE is operating in a mobility state. The one or more processors may be configured to forgo, based on the determination, an MPLMN scan of mmW frequency bands. The one or more processors may be configured to perform, based on the determination, an MPLMN scan of only non-mmW frequency bands for non-mmW cells.

Some aspects described herein relate to a UE for wireless communication. The UE may include a memory and one or more processors coupled to the memory. The one or more processors may be configured to perform an MPLMN scan of non-mmW frequency bands for non-mmW cells. The one or more processors may be configured to determine, based at least in part on performing the MPLMN scan, that no non-mmW cells were identified by the MPLMN scan. The one or more processors may be configured to forgo a second MPLMN scan of mmW frequency bands for mmW cells based at least in part on the determination.

Some aspects described herein relate to a UE for wireless communication. The UE may include a memory and one or more processors coupled to the memory. The one or more processors may be configured to perform an MPLMN scan of non-mmW frequency bands for non-mmW cells. The one or more processors may be configured to identify, based at least in part on performing the MPLMN scan, at least one non-mmW cell. The one or more processors may be configured to continue the MPLMN scan for one or more mmW cells that correspond to the at least one non-mmW cell.

Some aspects described herein relate to a UE for wireless communication. The user equipment may include a memory and one or more processors coupled to the memory. The one or more processors may be configured to perform an MPLMN scan of a first set of frequency bands based at least in part on a user preference, the first set of frequency bands comprising one of: non-mmW frequency bands, or mmW frequency bands. The one or more processors may be configured to provide data indicating a result of the MPLMN scan. The one or more processors may be configured to selectively continue the MPLMN scan, for a second set of frequency bands, based at least in part on one of: the user preference, or user input associated with the result of the MPLMN scan.

Some aspects described herein relate to a non-transitory computer-readable medium that stores a set of instructions for wireless communication by a UE. The set of instructions, when executed by one or more processors of the UE, may cause the UE to determine at least one of: the UE is not camped on a mmW cell and no neighboring cells are mmW cells, or the UE is operating in a mobility state. The set of instructions, when executed by one or more processors of the UE, may cause the UE to forgo, based on the determination, an MPLMN scan of mmW frequency bands. The set of instructions, when executed by one or more processors of the UE, may cause the UE to perform, based on the determination, an MPLMN scan of only non-mmW frequency bands for non-mmW cells.

Some aspects described herein relate to a non-transitory computer-readable medium that stores a set of instructions for wireless communication by a UE. The set of instructions, when executed by one or more processors of the UE, may cause the UE to perform an MPLMN scan of non-mmW frequency bands for non-mmW cells. The set of instructions, when executed by one or more processors of the UE, may cause the UE to determine, based at least in part on performing the MPLMN scan, that no non-mmW cells were identified by the MPLMN scan. The set of instructions, when executed by one or more processors of the UE, may cause the UE to forgo a second MPLMN scan of mmW frequency bands for mmW cells based at least in part on the determination.

Some aspects described herein relate to a non-transitory computer-readable medium that stores a set of instructions for wireless communication by a UE. The set of instructions, when executed by one or more processors of the UE, may cause the UE to perform an MPLMN scan of non-mmW frequency bands for non-mmW cells. The set of instructions, when executed by one or more processors of UE, may cause the UE to identify, based at least in part on performing the MPLMN scan, at least one non-mmW cell. The set of instructions, when executed by one or more processors of the UE, may cause the UE to continue the MPLMN scan for one or more mmW cells that correspond to the at least one non-mmW cell.

Some aspects described herein relate to a non-transitory computer-readable medium that stores a set of instructions for wireless communication by a UE. The set of instructions, when executed by one or more processors of the UE, may cause the UE to perform an MPLMN scan of a first set of frequency bands based at least in part on a user preference, the first set of frequency bands comprising one of: non-mmW frequency bands, or mmW frequency bands. The set of instructions, when executed by one or more processors of the UE, may cause the UE to provide data indicating a result of the MPLMN scan. The set of instructions, when executed by one or more processors of the UE, may cause the UE to selectively continue the MPLMN scan, for a second set of frequency bands, based at least in part on one of: the user preference, or user input associated with the result of the MPLMN scan.

Some aspects described herein relate to an apparatus for wireless communication. The apparatus may include means for determining at least one of: the UE is not camped on a mmW cell and no neighboring cells are mmW cells, or the UE is operating in a mobility state. The apparatus may include means for forgoing, based on the determination, an MPLMN scan of mmW frequency bands. The apparatus may include means for performing, based on the determination, an MPLMN scan of only non-mmW frequency bands for non-mmW cells.

Some aspects described herein relate to an apparatus for wireless communication. The apparatus may include means for performing an MPLMN scan of non-mmW frequency bands for non-mmW cells. The apparatus may include means for determining, based at least in part on performing the MPLMN scan, that no non-mmW cells were identified by the MPLMN scan. The apparatus may include means for forgoing a second MPLMN scan of mmW frequency bands for mmW cells based at least in part on the determination.

Some aspects described herein relate to an apparatus for wireless communication. The apparatus may include means for performing an MPLMN scan of non-mmW frequency bands for non-mmW cells. The apparatus may include means for identifying, based at least in part on performing the MPLMN scan, at least one non-mmW cell. The apparatus may include means for continuing the MPLMN scan for one or more mmW cells that correspond to the at least one non-mmW cell.

Some aspects described herein relate to an apparatus for wireless communication. The apparatus may include means for performing an MPLMN scan of a first set of frequency bands based at least in part on a user preference, the first set of frequency bands comprising one of: non-mmW frequency bands, or mmW frequency bands. The apparatus may include means for providing data indicating a result of the MPLMN scan. The apparatus may include means for selectively continuing the MPLMN scan, for a second set of frequency bands, based at least in part on one of: the user preference, or user input associated with the result of the MPLMN scan.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of manual public land mobile network (MPLMN) scanning, in accordance with the present disclosure.

FIGS. 4-7 are diagrams illustrating examples associated with MPLMN scanning, in accordance with the present disclosure.

FIGS. 8-11 are diagrams illustrating example processes associated with MPLMN scanning, in accordance with the present disclosure.

FIG. 12 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

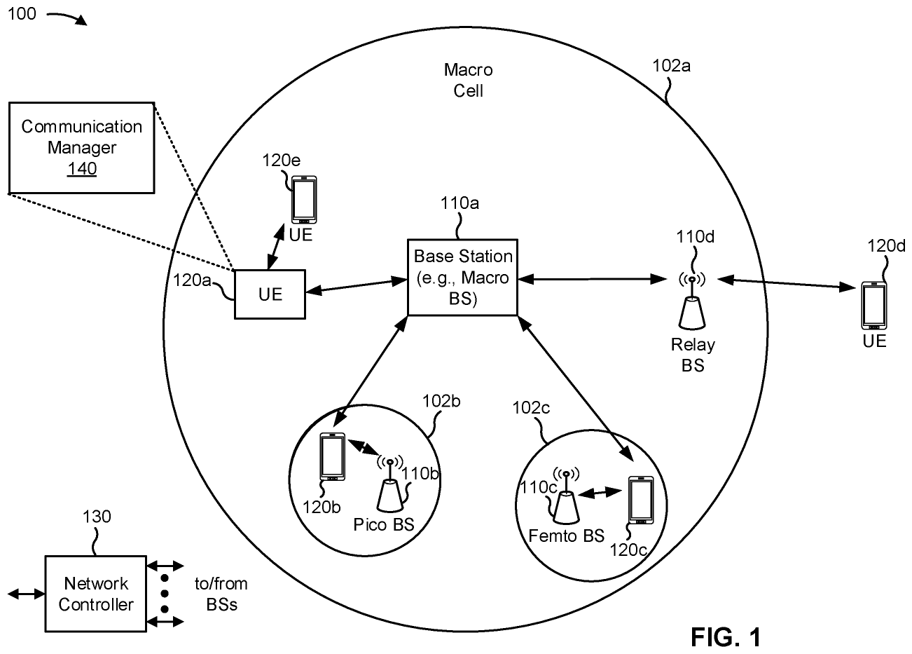

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V21) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” (mmW) band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may determine at least one of: the UE is not camped on a mmW cell and no neighboring cells are mmW cells, or the UE is operating in a mobility state; forgo, based on the determination, a manual public land mobile network (MPLMN) scan of mmW frequency bands; and perform, based on the determination, an MPLMN scan of only non-mmW frequency bands for non-mmW cells. Additionally, or alternatively, the communication manager 140 may perform an MPLMN scan of non-mmW frequency bands for non-mmW cells; determine, based at least in part on performing the MPLMN scan, that no non-mmW cells were identified by the MPLMN scan; and forgo a second MPLMN scan of mmW frequency bands for mmW cells based at least in part on the determination. Additionally, or alternatively, the communication manager 140 may perform an MPLMN scan of non-mmW frequency bands for non-mmW cells; identify, based at least in part on performing the MPLMN scan, at least one non-mmW cell; and continue the MPLMN scan for one or more mmW cells that correspond to the at least one non-mmW cell. Additionally, or alternatively, the communication manager 140 may perform an MPLMN scan of a first set of frequency bands based at least in part on a user preference, the first set of frequency bands comprising one of: non-mmW frequency bands, or mmW frequency bands; provide data indicating a result of the MPLMN scan; and selectively continue the MPLMN scan, for a second set of frequency bands, based at least in part on one of: the user preference, or user input associated with the result of the MPLMN scan. Additionally, or alternatively, the communication manager 140 may perform one or more other operations described herein.

As indicated above, FIG. 1 is provided as an example. Other examples may differ from what is described with regard to FIG. 1.

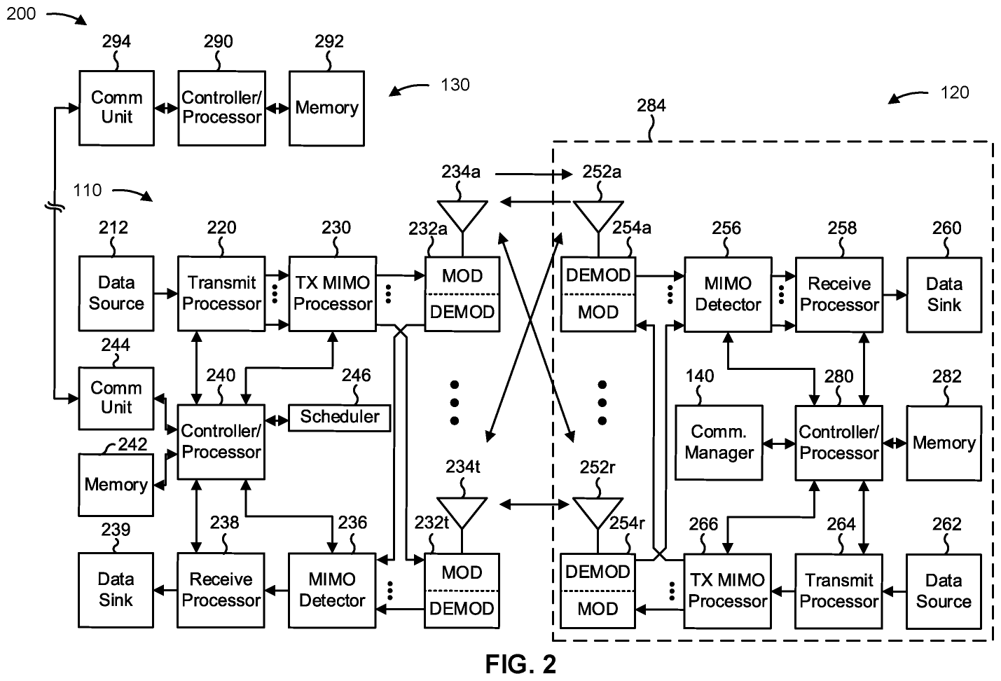

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T>1). The UE 120 may be equipped with a set of antennas 252a through 252r, such as R antennas (R>1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

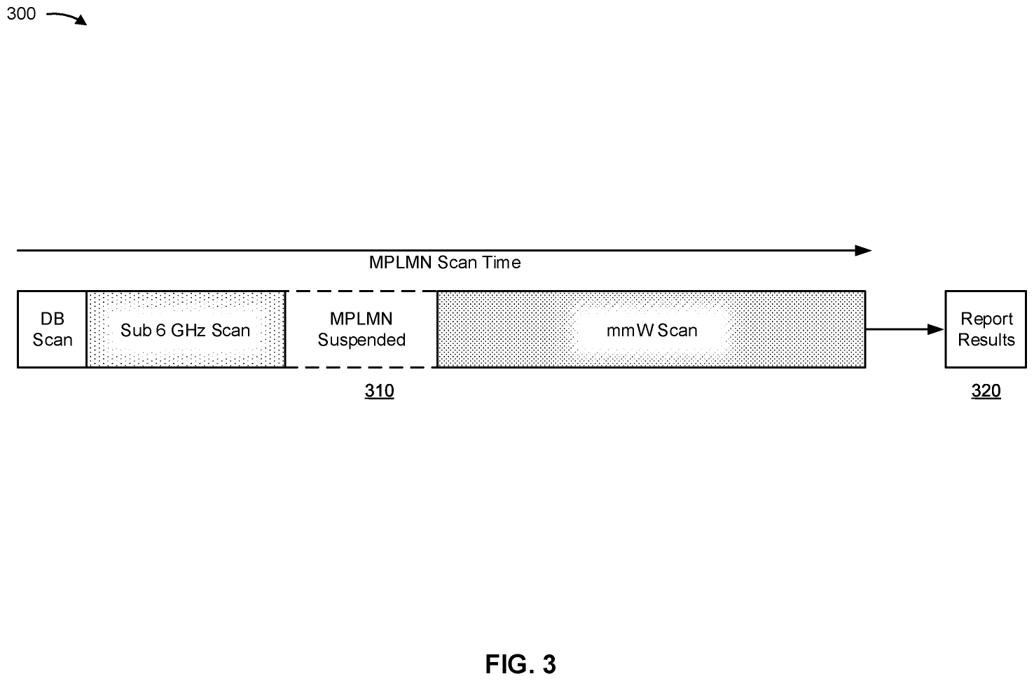

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 3-12).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 3-12).

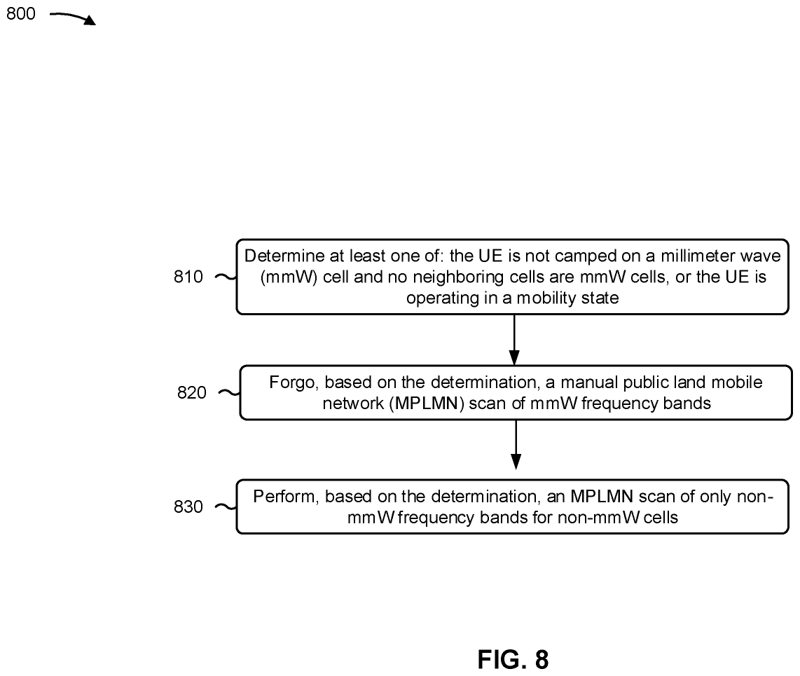

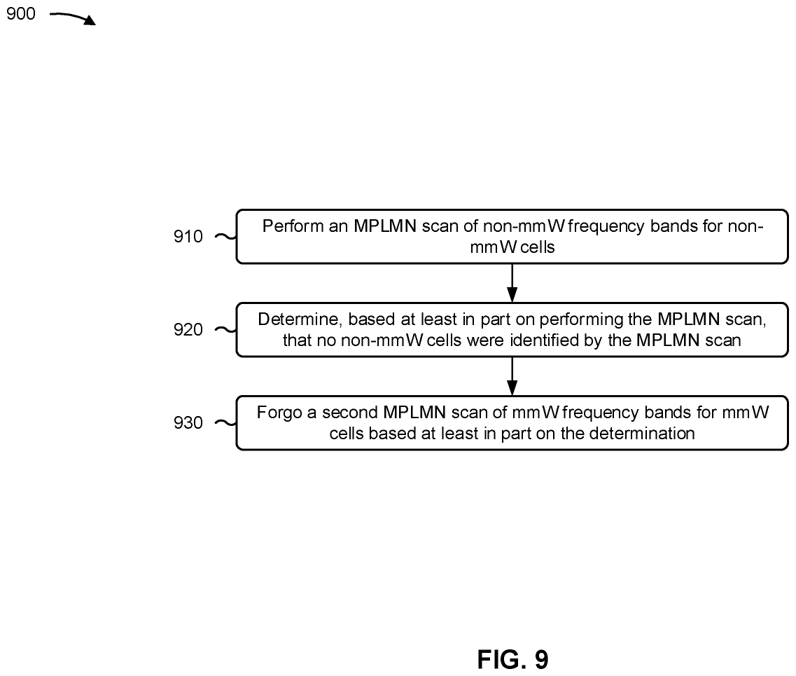

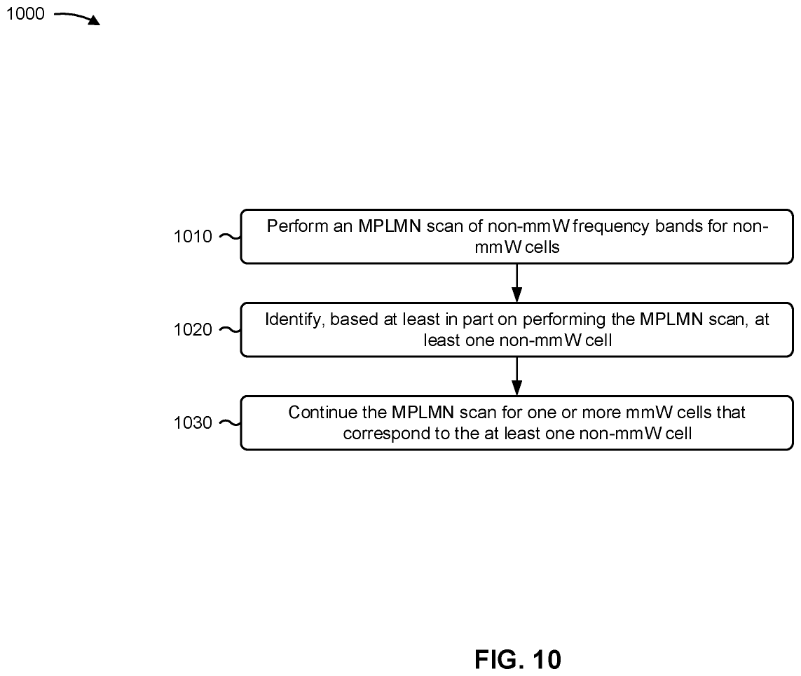

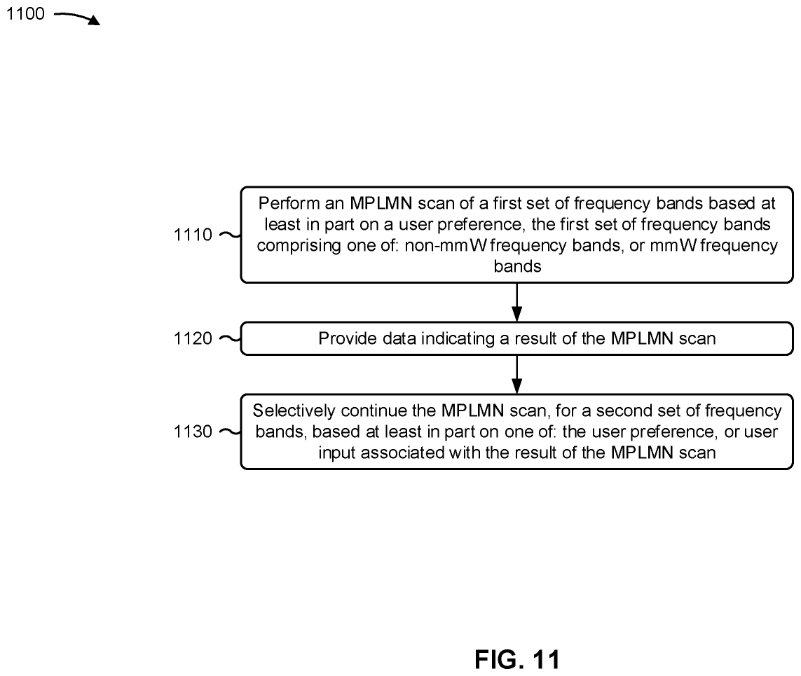

The controller/processor 240 of the base station 110, the controller/processor 280 of the UE 120, and/or any other component(s) of FIG. 2 may perform one or more techniques associated with selective MPLMN scanning, as described in more detail elsewhere herein. For example, the controller/processor 240 of the base station 110, the controller/processor 280 of the UE 120, and/or any other component(s) of FIG. 2 may perform or direct operations of, for example, process 800 of FIG. 8, process 900 of FIG. 9, process 1000 of FIG. 10, process 1100 of FIG. 11, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 800 of FIG. 8, process 900 of FIG. 9, process 1000 of FIG. 10, process 1100 of FIG. 11, and/or other processes as described herein. In some examples, executing instructions may include running the instructions, converting the instructions, compiling the instructions, and/or interpreting the instructions, among other examples.

In some aspects, the UE includes means for determining at least one of: the UE is not camped on a mmW cell and no neighboring cells are mmW cells, or the UE is operating in a mobility state; means for forgoing, based on the determination, an MPLMN scan of mmW frequency bands; and/or means for performing, based on the determination, an MPLMN scan of only non-mmW frequency bands for non-mmW cells. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the UE includes means for performing an MPLMN scan of non-mmW frequency bands for non-mmW cells; means for determining, based at least in part on performing the MPLMN scan, that no non-mmW cells were identified by the MPLMN scan; and/or means for forgoing a second MPLMN scan of mmW frequency bands for mmW cells based at least in part on the determination. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the UE includes means for performing an MPLMN scan of non-mmW frequency bands for non-mmW cells; means for identifying, based at least in part on performing the MPLMN scan, at least one non-mmW cell; and/or means for continuing the MPLMN scan for one or more mmW cells that correspond to the at least one non-mmW cell. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the UE includes means for performing an MPLMN scan of a first set of frequency bands based at least in part on a user preference, the first set of frequency bands comprising one of: non-mmW frequency bands, or mmW frequency bands; means for providing data indicating a result of the MPLMN scan; and/or means for selectively continuing the MPLMN scan, for a second set of frequency bands, based at least in part on one of: the user preference, or user input associated with the result of the MPLMN scan. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

FIG. 3 is a diagram illustrating an example 300 of MPLMN scanning, in accordance with the present disclosure. As shown in FIG. 3, a UE (e.g., UE 120) may perform an MPLMN scan to select a PLMN and acquire a cell (e.g., corresponding to a base station, such as base station 110) with which the UE may establish a connection for subsequent network communications.

In order to communicate via a PLMN, such as network 100, the UE is responsible for selecting a PLMN for subsequent cell selection. For example, the UE may select a home PLMN (HPLMN) or a visited PLMN (VPLMN) that provides wireless coverage to the UE to obtain various communication services. The UE may provide a manual selection mode (e.g., MPLMN) to enable a user to scan for available PLMNs and select a preferred PLMN from which to obtain service. For example, a user may prefer the UE to camp on or attach to a particular PLMN of multiple available PLMNs and may indicate a particular PLMN, such as via a user interaction with a user interface. In this case, the UE may camp on or attempt to attach to the particular PLMN (e.g., an HPLMN, VPLMN, or other PLMN).

As shown by reference number 310, a UE may perform an MPLMN scan to identify available PLMNs. For example, the UE may scan all RF channels within its supported frequency bands for system information blocks (SIBs), which may be broadcast by various PLMNs and may include information identifying the PLMNs. Example frequency bands may include mmW bands, as described herein (e.g., FR2), and non-mmW bands, which may include frequency bands other than those included in mmW bands, such as Sub-6 GHz frequency bands (e.g., FR1) as well as other frequency bands associated with other radio access technologies (RATs). In some aspects, the UE may search for the strongest cell on each carrier and read the system information (e.g., in the SIBs) to identify the PLMN. The UE may optimize the PLMN search using stored information, also known as an acquisition database scan (e.g., “DB scan”), which may include a scan of carrier frequencies and/or other cell parameters associated with cells for which the UE has previously stored information (e.g., based on prior scans, prior connections, prior configurations, and/or the like).

When an MPLMN scan is selected (e.g., by a user of the UE), as opposed to other forms of PLMN scanning, the UE scans all supported frequency bands before presenting the results of the scan. As further shown by reference number 310, the MPLMN scan may begin with the acquisition database scan, followed by a Sub-6 GHz frequency band scan. After the Sub-6 GHz scan, the UE may perform a mmW scan for cells that support mmW communications. In some situations, the UE may perform a scan of other RATs either before or after the mmW scan. In some situations, the MPLMN scan may be suspended for a duration of time to enable the UE to perform another action, such as establish a connection with one of the cells identified in the acquisition database scan or the Sub-6 GHz scan.

As shown by reference number 320, after the MPLMN scan is completed, including searches of other radio access technologies (RATs) that might be included in an MPLMN scan (e.g., frequency bands other than non-mmW and mmW), the UE may report results to the user (e.g., display results via a user interface of the UE). Because the results of the MPLMN scan are not presented to the user until the MPLMN scan is finished, a user may wait an extended period of time for the MPLMN scan to be complete before being able to select a cell from the results of the scan. The lengthy MPLMN scan may also use significant UE resources for an extended period of time, such as network resources, power resources, and processing resources.

Some techniques and apparatuses described herein enable a UE to perform a selective MPLMN scan that may take less time and consume fewer UE resources. For example, based at least in part on whether the UE is camped on a cell with no neighboring mmW cells or is operating in a mobility state (e.g., moving faster than a threshold rate of speed), the UE may only scan non-mmW frequency bands and forgo scanning for mmW cells. As another example, the UE may perform a non-mmW scan first and, based at least in part on the results of the non-mmW scan, forgo the mmW scan (e.g., if no non-mmW cells were identified by the non-mmW scan) or continue the MPLMN scan for cells that correspond to the non-mmW cells that were identified by the non-mmW scan. As yet another example, the UE may perform the MPLMN scan based at least in part on a user preference; where the user preference indicates a non-mmW preference (or no preference), the UE may perform the non-mmW scan and report results before proceeding to the mmW scan; where the user preference indicates a mmW preference, the UE may perform the mmW scan and report results before proceeding to the non-mmW scan. In this way, the UE may selectively perform an MPLMN scan, which may result in the UE spending less time and resources scanning and may provide results of the MPLMN scan to the user of the UE faster than with other MPLMN scanning methods. As a result, the UE may conserve time, network resources, power resources, and processing resources when performing MPLMN scans.

As indicated above, FIG. 3 is provided as an example. The example time scale, illustrating relative amounts of time being taken by various portions of the MPLMN scan, is for illustration purposes only and may not be representative of the actual relative amounts of time taken for various portions of the MPLMN scan. Other examples may differ from what is described with respect to FIG. 3.

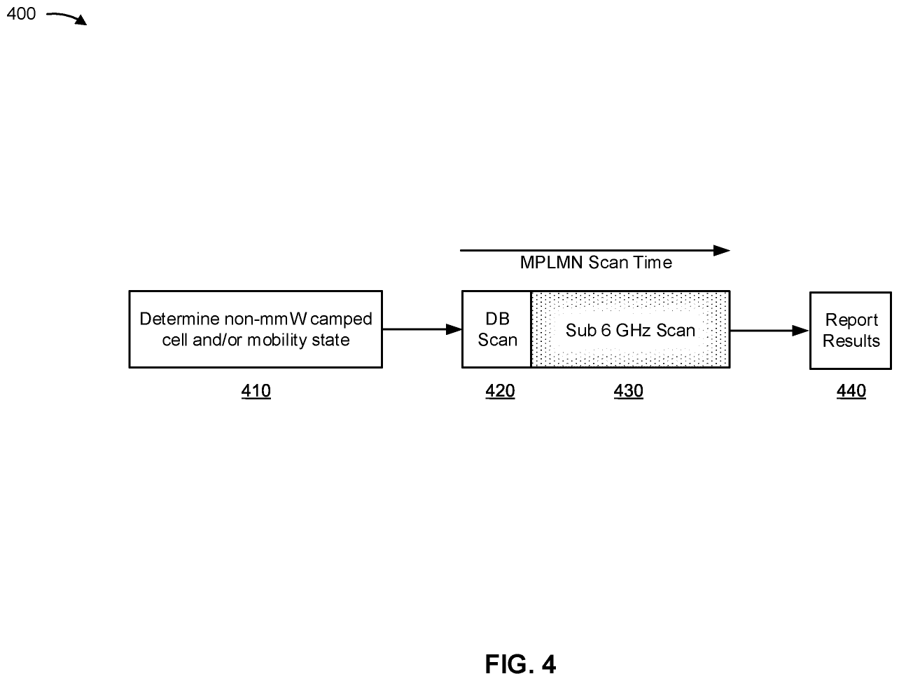

FIG. 4 is a diagram illustrating an example 400 associated with selective manual public land mobile network scanning, in accordance with the present disclosure. As shown in FIG. 4, a UE (e.g., UE 120) may perform a selective MPLMN scan (e.g., based at least in part on user input from a user indicating that an MPLMN scan should be initiated).

As shown by reference number 410, prior to performing the MPLMN scan, the UE may determine that the UE is not camped on a mmW cell and that no neighboring cells are mmW cells, or determine that the UE is operating in a mobility state. For example, in a situation where the UE is not camped on a mmW cell, and no neighboring cells are mmW cells, the UE may forgo a mmW scan, as the UE will not identify any mmW cells associated with the currently camped cell or any neighboring cells (e.g., based at least in part on information regarding the cell and the neighboring cells provided, for example, by the currently camped cell). Similarly, when operating in a mobility state, where the UE is considered mobile (e.g., moving at a speed greater than a speed threshold), a mmW scan may not be beneficial, as the UE may move outside of a coverage area of a mmW cell quickly (e.g., due to mmW cells having a relatively short range) when the UE is moving. Accordingly, determining that the UE is camped on a cell that is not a mmW cell and that has no mmW neighbors, and/or determining that the UE is operating in a mobility state, may lead the UE to selectively perform the MPLMN scan in a manner that forgos a mmW scan (e.g., a scan of mmW frequency bands).

As shown by reference number 420, in some aspects, the UE may begin the MPLMN scan with an acquisition database scan, which may include a scan of carrier frequencies and/or other cell parameters associated with cells for which the UE has previously stored information (e.g., based on prior scans, prior connections, prior configurations, and/or the like). For example, the acquisition database scan may include a scan of historical cells associated with a location of the UE (e.g., the UE may search for cells associated with a current location of the UE). As the acquisition database scan is generally fast and focused on particular cells, the acquisition database scan may include both mmW cells and non-mmW cells.

As shown by reference number 430, the UE may perform the MPLMN scan of only non-mmW frequency bands (e.g., Sub-6 GHz and/or other RAT frequency bands). As described herein, based at least in part on the determination that the UE is camped on a cell that is not a mmW cell and that has no mmW neighbors, and/or determining that the UE is operating in a mobility state, the UE may forgo the scanning of mmW frequency bands and only scan non-mmW frequency bands.

As shown by reference number 440, the UE may report results of the MPLMN scan. For example, as described herein, the UE may provide results of the MPLMN scan (e.g., identified cells, cell signal strength indicators, and/or the like) in a user interface. The user interface may enable a user of the UE to select from results, in which case the UE may attempt to attach to the selected cell, as described herein.

As indicated above, FIG. 4 is provided as an example. The example time scale, provided for FIG. 4 and other figures included herein, illustrates relative amounts of time being taken by various portions of the MPLMN scan. The example time scale, including the illustrated relative amounts of time, is for illustration purposes only and may not be representative of the actual relative amounts of time taken for various portions of the MPLMN scan. Other examples may differ from what is described with respect to FIG. 4.

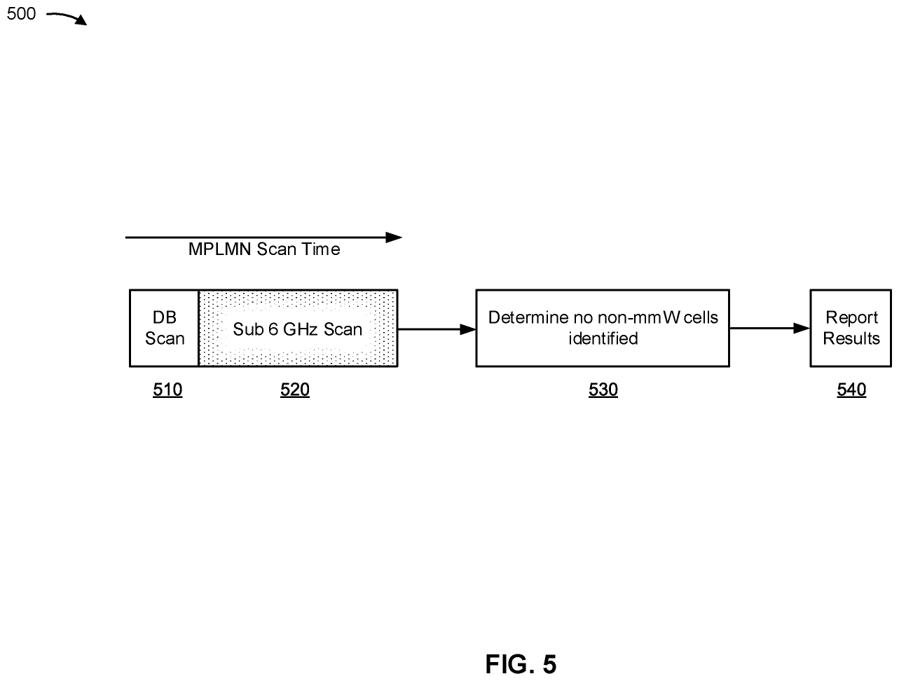

FIG. 5 is a diagram illustrating an example 500 associated with selective manual public land mobile network scanning, in accordance with the present disclosure. As shown in FIG. 5, a UE (e.g., UE 120) may perform a selective MPLMN scan.

As shown by reference number 510, in some aspects, the UE may begin the MPLMN scan with an acquisition database scan, as described herein.

As shown by reference number 520, the UE may continue the MPLMN scan with a scan of non-mmW cells (e.g., including the Sub-6 GHz frequency bands and, in some situations, other RAT frequency bands), as described herein.

As shown by reference number 530, after the non-mmW scan, the UE may determine, based at least in part on performing the non-mmW scan, that no non-mmW cells were identified by the non-mmW scan. Because mmW cells may be co-located with non-mmW cells, the determination that no non-mmW cells were identified may enable the UE to assume that it will not identify any mmW cells (e.g., at least those co-located with non-mmW cells). Accordingly, the determination may lead the UE to forgo a mmW scan once the non-mmW scan has completed without identifying any mmW cells.

As shown by reference number 540, the UE reports the results of the MPLMN scan to the user without performing a scan of the mmW frequency bands, as described herein.

As indicated above, FIG. 5 is provided as an example. Other examples may differ from what is described with respect to FIG. 5.

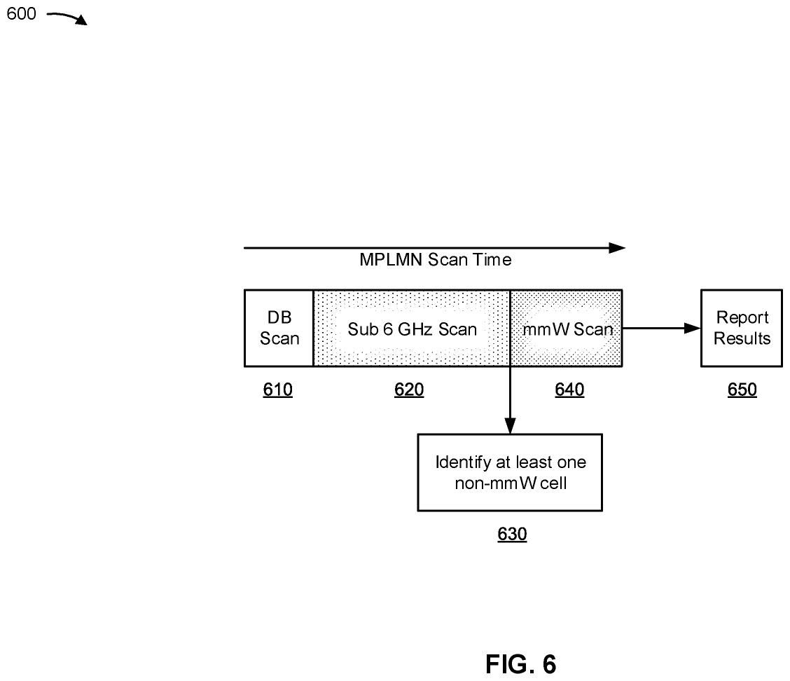

FIG. 6 is a diagram illustrating an example 600 associated with selective manual public land mobile network scanning, in accordance with the present disclosure. As shown in FIG. 6, a UE (e.g., UE 120) may perform a selective MPLMN scan.

As shown by reference number 610, in some aspects, the UE may begin the MPLMN scan with an acquisition database scan, as described herein.

As shown by reference number 620, the UE may continue the MPLMN scan with a scan of non-mmW cells (e.g., including the Sub-6 GHz frequency bands and, in some situations, other RAT frequency bands), as described herein.

As shown by reference number 630, after the non-mmW scan, the UE may identify, based at least in part on performing the non-mmW scan, at least one non-mmW cell (e.g., at least one non-mmW cell identified by the non-mmW scan). Because mmW cells may be co-located with non-mmW cells, and because of the relatively short range of mmW cells, the UE may assume that a mmW scan would not identify any mmW cells other than those co-located with the identified non-mmW cells. Accordingly, the identification of at least one non-mmW cell may cause the UE to continue the MPLMN scan for mmW cells that correspond to the identified non-mmW cell(s), but forgo a mmW scan for other mmW cells.

As shown by reference number 640, the UE may continue the MPLMN scan for one or more mmW cells that correspond to the non-mmW cell(s) identified by the non-mmW scan. For example, rather than performing a full PLMN scan of mmW frequency bands, the UE may only search on mmW resources (e.g., frequency resources, time resources, and spatial resources) associated with mmW cells that correspond to the non-mmW cells previously identified by the non-mmW scan. In some cases, the mmW resources may be indicated by system information or other communications broadcast by the non-mmW cells.

As shown by reference number 650, the UE reports the results of the MPLMN scan to the user. The results may include results for both the non-mmW and mmW scans, as described herein.

As indicated above, FIG. 6 is provided as an example. Other examples may differ from what is described with respect to FIG. 6.

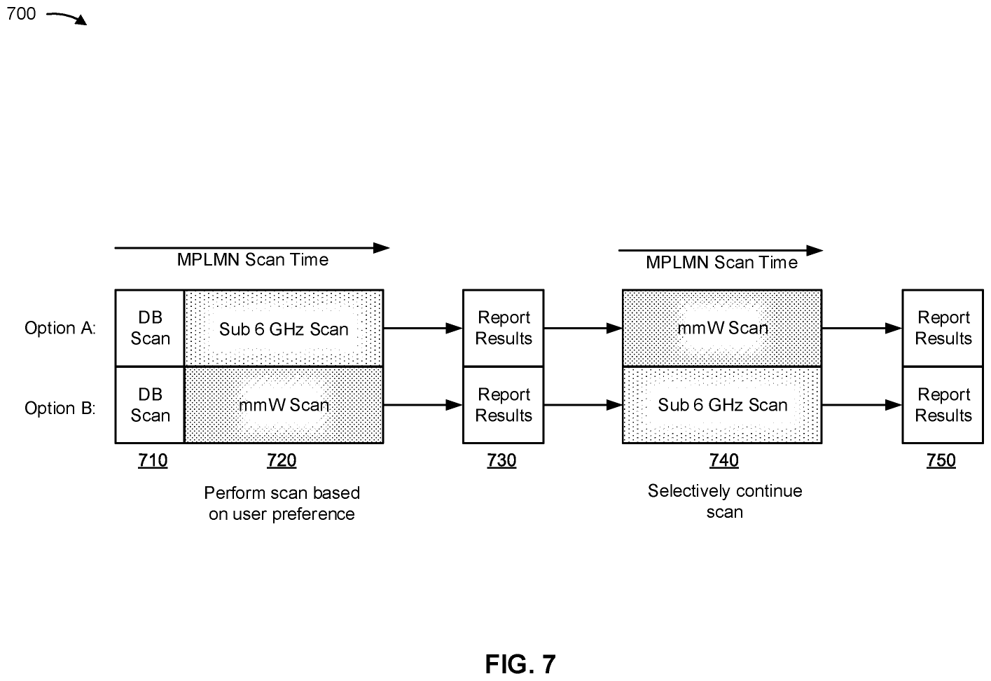

FIG. 7 is a diagram illustrating an example 700 associated with selective manual public land mobile network scanning, in accordance with the present disclosure. As shown in FIG. 7, a UE (e.g., UE 120) may perform a selective MPLMN scan. The example 700 depicts two options: option A and option B, which are associated with example user preferences. Option A is associated with a user preference to perform a non-mmW scan (or a user preference specifying no preference, in which case Option A is assumed), while Option B is associated with a user preference to perform a mmW scan. For each option, the UE may perform an MPLMN scan for one set of frequency bands, report results, and optionally continue the MPLMN scan on another set of frequency bands, as described herein.

As shown by reference number 710, in some aspects, the UE may begin the MPLMN scan with an acquisition database scan, as described herein.

As shown by reference number 720, the UE may perform an MPLMN scan on a first set of frequency bands based at least in part on a user preference. The first set of frequency bands may include non-mmW frequency bands or mmW frequency bands. In a situation where the user preference indicates a non-mmW preference, or no preference, the UE may perform the MPLMN scan for non-mmW cells (e.g., including the Sub-6 GHz frequency bands and, in some situations, other RAT frequency bands), as described herein. In a situation where the user preference indicates a mmW preference, the UE may perform the MPLMN scan for mmW cells, as described herein.

As shown by reference number 730, the UE reports the results of the MPLMN scan to the user. The results may include results for either the non-mmW (e.g., in Option A) or mmW (e.g., in Option B) scans, depending on the user preference.

After reporting the results of the MPLMN scan of non-mmW or mmW frequency bands based on the user preference, the UE may take a variety of actions. In some aspects, the UE may enable the user to indicate (e.g., via user input provided to a user interface of the UE) whether the UE should continue the MPLMN scan, and/or whether the user should connect to one of the cells identified by the results (e.g., based on user selection of the result via the user interface of the UE). In some aspects, the UE may end the MPLMN scan after scanning the first set of frequency bands. In some aspects, the UE may attempt to attach to a cell identified in the results. In some aspects, the actions taken after reporting the results may be pre-configured (e.g., either a default configuration or user specified) and/or may be dynamically selected (e.g., via user input) after the scan of the first set of frequency bands.

As shown by reference number 740, after reporting results of the MPLMN scan of the first set of frequency bands, the UE may continue the MPLMN scan of the second set of frequency bands. In some aspects, as noted above, the UE may continue the MPLMN scan by default, based on a configuration of the UE, based on user input, and/or the like. In a situation where the first set of frequency bands includes non-mmW frequency bands (e.g., Option A), the MPLMN scan of the second set of frequency bands includes a scan of mmW frequency bands, as described herein. In a situation where the first set of frequency bands includes mmW frequency bands (e.g., Option B), the MPLMN scan of the second set of frequency bands includes a scan of non-mmW frequency bands, as described herein.

As shown by reference number 750, the UE reports the results of the continued MPLMN scan to the user. The results may include results for the non-mmW (e.g., in Option B) or mmW (e.g., in Option A) scans, depending on the user preference, as described herein.

As indicated above, FIG. 7 is provided as an example. Other examples may differ from what is described with respect to FIG. 7.

FIG. 8 is a diagram illustrating an example process 800 performed, for example, by a UE, in accordance with the present disclosure. Example process 800 is an example where the UE (e.g., UE 120) performs operations associated with selective manual public land mobile network scanning.

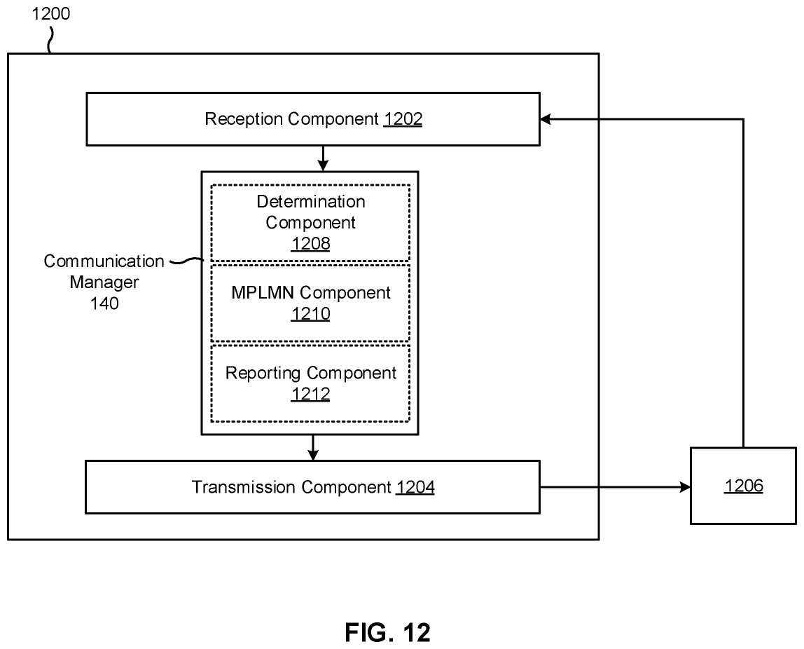

As shown in FIG. 8, in some aspects, process 800 may include determining at least one of: the UE is not camped on a mmW cell and no neighboring cells are mmW cells, or the UE is operating in a mobility state (block 810). For example, the UE (e.g., using communication manager 140 and/or determination component 1208, depicted in FIG. 12) may determine at least one of: the UE is not camped on a mmW cell and no neighboring cells are mmW cells, or the UE is operating in a mobility state, as described above.

As further shown in FIG. 8, in some aspects, process 800 may include forgoing, based on the determination, an MPLMN scan of mmW frequency bands (block 820). For example, the UE (e.g., using communication manager 140 and/or MPLMN component 1210, depicted in FIG. 12) may forgo, based on the determination, an MPLMN scan of mmW frequency bands, as described above.

As further shown in FIG. 8, in some aspects, process 800 may include performing, based on the determination, an MPLMN scan of only non-mmW frequency bands for non-mmW cells (block 830). For example, the UE (e.g., using communication manager 140 and/or MPLMN component 1210, depicted in FIG. 12) may perform, based on the determination, an MPLMN scan of only non-mmW frequency bands for non-mmW cells, as described above.

Process 800 may include additional aspects, such as any single aspect or any combination of aspects described below and/or in connection with one or more other processes described elsewhere herein.

In a first aspect, the non-mmW frequency bands include sub-6 GHz frequency bands.

In a second aspect, alone or in combination with the first aspect, the mobility state is associated with the UE moving at a speed that satisfies a speed threshold.

In a third aspect, alone or in combination with one or more of the first and second aspects, process 800 includes performing an acquisition database scan prior to performing the MPLMN scan, the acquisition database scan comprising a scan of historical cells associated with a location of the UE.

In a fourth aspect, alone or in combination with one or more of the first through third aspects, process 800 includes providing data indicating a result of the MPLMN scan.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a UE, in accordance with the present disclosure. Example process 900 is an example where the UE (e.g., UE 120) performs operations associated with selective manual public land mobile network scanning.

As shown in FIG. 9, in some aspects, process 900 may include performing an MPLMN scan of non-mmW frequency bands for non-mmW cells (block 910). For example, the UE (e.g., using communication manager 140 and/or MPLMN component 1210, depicted in FIG. 12) may perform an MPLMN scan of non-mmW frequency bands for non-mmW cells, as described above.

As further shown in FIG. 9, in some aspects, process 900 may include determining, based at least in part on performing the MPLMN scan, that no non-mmW cells were identified by the MPLMN scan (block 920). For example, the UE (e.g., using communication manager 140 and/or determination component 1208, depicted in FIG. 12) may determine, based at least in part on performing the MPLMN scan, that no non-mmW cells were identified by the MPLMN scan, as described above.

As further shown in FIG. 9, in some aspects, process 900 may include forgoing a second MPLMN scan of mmW frequency bands for mmW cells based at least in part on the determination (block 930). For example, the UE (e.g., using communication manager 140 and/or MPLMN component 1210, depicted in FIG. 12) may forgo a second MPLMN scan of mmW frequency bands for mmW cells based at least in part on the determination, as described above.

Process 900 may include additional aspects, such as any single aspect or any combination of aspects described below and/or in connection with one or more other processes described elsewhere herein.

In a first aspect, the non-mmW frequency bands include sub-6 GHz frequency bands.

In a second aspect, alone or in combination with the first aspect, process 900 includes performing an acquisition database scan prior to performing the MPLMN scan, the acquisition database scan comprising a scan of historical cells associated with a location of the UE.

In a third aspect, alone or in combination with one or more of the first and second aspects, process 900 includes providing data indicating a result of the MPLMN scan.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, by a UE, in accordance with the present disclosure. Example process 1000 is an example where the UE (e.g., UE 120) performs operations associated with selective manual public land mobile network scanning.

As shown in FIG. 10, in some aspects, process 1000 may include performing an MPLMN scan of non-mmW frequency bands for non-mmW cells (block 1010). For example, the UE (e.g., using communication manager 140 and/or MPLMN component 1210, depicted in FIG. 12) may perform an MPLMN scan of non-mmW frequency bands for non-mmW cells, as described above.

As further shown in FIG. 10, in some aspects, process 1000 may include identifying, based at least in part on performing the MPLMN scan, at least one non-mmW cell (block 1020). For example, the UE (e.g., using communication manager 140 and/or MPLMN component 1210, depicted in FIG. 12) may identify, based at least in part on performing the MPLMN scan, at least one non-mmW cell, as described above.

As further shown in FIG. 10, in some aspects, process 1000 may include continuing the MPLMN scan for one or more mmW cells that correspond to the at least one non-mmW cell (block 1030). For example, the UE (e.g., using communication manager 140 and/or MPLMN component 1210, depicted in FIG. 12) may continue the MPLMN scan for one or more mmW cells that correspond to the at least one non-mmW cell, as described above.

Process 1000 may include additional aspects, such as any single aspect or any combination of aspects described below and/or in connection with one or more other processes described elsewhere herein.

In a first aspect, the non-mmW frequency bands include sub-6 GHz frequency bands.

In a second aspect, alone or in combination with the first aspect, process 1000 includes performing an acquisition database scan prior to performing the MPLMN scan, the acquisition database scan comprising a scan of historical cells associated with a location of the UE.

In a third aspect, alone or in combination with one or more of the first and second aspects, the one or more mmW cells correspond to the at least one non-mmW cell by being geographically co-located with the at least one non-mmW cell.

In a fourth aspect, alone or in combination with one or more of the first through third aspects, process 1000 includes providing data indicating a result of the MPLMN scan.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, by a UE, in accordance with the present disclosure. Example process 1100 is an example where the UE (e.g., UE 120) performs operations associated with selective manual public land mobile network scanning.

As shown in FIG. 11, in some aspects, process 1100 may include performing an MPLMN scan of a first set of frequency bands based at least in part on a user preference, the first set of frequency bands comprising one of: non-mmW frequency bands, or mmW frequency bands (block 1110). For example, the UE (e.g., using communication manager 140 and/or MPLMN component 1210, depicted in FIG. 12) may perform an MPLMN scan of a first set of frequency bands based at least in part on a user preference, the first set of frequency bands comprising one of: non-mmW frequency bands, or mmW frequency bands, as described above.

As further shown in FIG. 11, in some aspects, process 1100 may include providing data indicating a result of the MPLMN scan (block 1120). For example, the UE (e.g., using communication manager 140 and/or reporting component 1212, depicted in FIG. 12) may provide data indicating a result of the MPLMN scan, as described above.

As further shown in FIG. 11, in some aspects, process 1100 may include selectively continuing the MPLMN scan, for a second set of frequency bands, based at least in part on one of: the user preference, or user input associated with the result of the MPLMN scan (block 1130). For example, the UE (e.g., using communication manager 140 and/or MPLMN component 1210, depicted in FIG. 12) may selectively continue the MPLMN scan, for a second set of frequency bands, based at least in part on one of: the user preference, or user input associated with the result of the MPLMN scan, as described above.

Process 1100 may include additional aspects, such as any single aspect or any combination of aspects described below and/or in connection with one or more other processes described elsewhere herein.

In a first aspect, the first set of frequency bands comprises the non-mmW frequency bands, and the second set of frequency bands comprises the mmW frequency bands.

In a second aspect, alone or in combination with the first aspect, the first set of frequency bands comprises the mmW frequency bands, and the second set of frequency bands comprises the non-mmW frequency bands.

In a third aspect, alone or in combination with one or more of the first and second aspects, the first set of frequency bands comprises the non-mmW frequency bands based at least in part on the user preference specifying no preference.

In a fourth aspect, alone or in combination with one or more of the first through third aspects, the non-mmW frequency bands include sub-6 GHz frequency bands.

In a fifth aspect, alone or in combination with one or more of the first through fourth aspects, process 1100 includes performing an acquisition database scan prior to performing the MPLMN scan, the acquisition database scan comprising a scan of historical cells associated with a location of the UE.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

Accordingly, some techniques and apparatuses described herein enable a UE to perform a selective MPLMN scan that may take less time and consume less UE resources than a traditional MPLMN scan. For example, based at least in part on whether the UE is camped on a cell with no neighboring mmW cells or is operating in a mobility state (e.g., moving faster than a threshold rate of speed), the UE may only scan non-mmW frequency bands and forgo scanning for mmW cells. As another example, the UE may perform a non-mmW scan first and, based at least in part on the results of the non-mmW scan, forgo the mmW scan (e.g., if no non-mmW cells were identified by the non-mmW scan) or continue the MPLMN scan for cells that correspond to the non-mmW cells that were identified by the non-mmW scan. As yet another example, the UE may perform the MPLMN scan based at least in part on a user preference; where the user preference indicates a non-mmW preference (or no preference), the UE may perform the non-mmW scan and report results before proceeding to the mmW scan; where the user preference indicates a mmW preference, the UE may perform the mmW scan and report results before proceeding to the non-mmW scan. In this way, the UE may selectively perform an MPLMN scan, which may result in the UE spending less time and resources scanning and may provide results of the MPLMN scan to the user of the UE faster than with other MPLMN scanning methods. As a result, the UE may conserve time, network resources, power resources, and processing resources when performing MPLMN scans.

FIG. 12 is a diagram of an example apparatus 1200 for wireless communication. The apparatus 1200 may be a UE, or a UE may include the apparatus 1200. In some aspects, the apparatus 1200 includes a reception component 1202 and a transmission component 1204, which may be in communication with one another (for example, via one or more buses and/or one or more other components). As shown, the apparatus 1200 may communicate with another apparatus 1206 (such as a UE, a base station, or another wireless communication device) using the reception component 1202 and the transmission component 1204. As further shown, the apparatus 1200 may include the communication manager 140. The communication manager 140 may include one or more of a determination component 1208, an MPLMN component 1210, or a reporting component 1212, among other examples.

In some aspects, the apparatus 1200 may be configured to perform one or more operations described herein in connection with FIGS. 3-7. Additionally, or alternatively, the apparatus 1200 may be configured to perform one or more processes described herein, such as process 800 of FIG. 8, process 900 of FIG. 9, process 1000 of FIG. 10, process 1100 of FIG. 11, or a combination thereof In some aspects, the apparatus 1200 and/or one or more components shown in FIG. 12 may include one or more components of the UE described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1206. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, a modem, a demodulator, a MIMO detector, a receive processor, a controller/processor, a memory, or a combination thereof, of the UE described in connection with FIG. 2.

The transmission component 1204 may transmit communications, such as reference signals, control information, data communications, or a combination thereof, to the apparatus 1206. In some aspects, one or more other components of the apparatus 1200 may generate communications and may provide the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, a modem, a modulator, a transmit MIMO processor, a transmit processor, a controller/processor, a memory, or a combination thereof, of the UE described in connection with FIG. 2. In some aspects, the transmission component 1204 may be co-located with the reception component 1202 in a transceiver.

The determination component 1208 may determine at least one of: the UE is not camped on a mmW cell and no neighboring cells are mmW cells, or the UE is operating in a mobility state. The MPLMN component 1210 may forgo, based on the determination, an MPLMN scan of mmW frequency bands. The MPLMN component 1210 may perform, based on the determination, an MPLMN scan of only non-mmW frequency bands for non-mmW cells.

The MPLMN component 1210 may perform an acquisition database scan prior to performing the MPLMN scan, the acquisition database scan comprising a scan of historical cells associated with a location of the UE.

The MPLMN component 1210 may perform an MPLMN scan of non-mmW frequency bands for non-mmW cells. The determination component 1208 may determine, based at least in part on performing the MPLMN scan, that no non-mmW cells were identified by the MPLMN scan. The MPLMN component 1210 may forgo a second MPLMN scan of mmW frequency bands for mmW cells based at least in part on the determination.

The MPLMN component 1210 may perform an acquisition database scan prior to performing the MPLMN scan, the acquisition database scan comprising a scan of historical cells associated with a location of the UE.

The MPLMN component 1210 may perform an MPLMN scan of non-mmW frequency bands for non-mmW cells. The MPLMN component 1210 may identify, based at least in part on performing the MPLMN scan, at least one non-mmW cell. The MPLMN component 1210 may continue the MPLMN scan for one or more mmW cells that correspond to the at least one non-mmW cell.

The MPLMN component 1210 may perform an MPLMN scan of a first set of frequency bands based at least in part on a user preference, the first set of frequency bands comprising one of non-mmW frequency bands, or mmW frequency bands. The MPLMN component 1210 may selectively continue the MPLMN scan, for a second set of frequency bands, based at least in part on one of the user preference, or user input associated with the result of the MPLMN scan.

The reporting component 1212 may provide data indicating a result of the MPLMN scan.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

The following provides an overview of some Aspects of the present disclosure:

Aspect 1: A method of wireless communication performed by a UE, comprising: determining at least one of: the UE is not camped on a mmW cell and no neighboring cells are mmW cells, or the UE is operating in a mobility state; forgoing, based on the determination, an MPLMN scan of mmW frequency bands; and performing, based on the determination, an MPLMN scan of only non-mmW frequency bands for non-mmW cells.

Aspect 2: The method of Aspect 1, wherein the non-mmW frequency bands include sub-6 GHz frequency bands.

Aspect 3: The method of any of Aspects 1-2, wherein the mobility state is associated with the UE moving at a speed that satisfies a speed threshold.

Aspect 4: The method of any of Aspects 1-3, further comprising: performing an acquisition database scan prior to performing the MPLMN scan, the acquisition database scan comprising a scan of historical cells associated with a location of the UE.

Aspect 5: The method of any of Aspects 1-4, further comprising: providing data indicating a result of the MPLMN scan.

Aspect 6: A method of wireless communication performed by a UE, comprising: performing an MPLMN scan of non-mmW frequency bands for non-mmW cells; determining, based at least in part on performing the MPLMN scan, that no non-mmW cells were identified by the MPLMN scan; and forgoing a second MPLMN scan of mmW frequency bands for mmW cells based at least in part on the determination.

Aspect 7: The method of Aspect 6, wherein the non-mmW frequency bands include sub-6 GHz frequency bands.

Aspect 8: The method of any of Aspects 6-7, further comprising: performing an acquisition database scan prior to performing the MPLMN scan, the acquisition database scan comprising a scan of historical cells associated with a location of the UE.

Aspect 9: The method of any of Aspects 6-8, further comprising: providing data indicating a result of the MPLMN scan.

Aspect 10: A method of wireless communication performed by a UE, comprising: performing an MPLMN scan of non-mmW frequency bands for non-mmW cells; identifying, based at least in part on performing the MPLMN scan, at least one non-mmW cell; and continuing the MPLMN scan for one or more mmW cells that correspond to the at least one non-mmW cell.

Aspect 11: The method of Aspect 10, wherein the non-mmW frequency bands include sub-6 GHz frequency bands.

Aspect 12: The method of any of Aspects 10-11, further comprising: performing an acquisition database scan prior to performing the MPLMN scan, the acquisition database scan comprising a scan of historical cells associated with a location of the UE.

Aspect 13: The method of any of Aspects 10-12, wherein the one or more mmW cells correspond to the at least one non-mmW cell by being geographically co-located with the at least one non-mmW cell.

Aspect 14: The method of any of Aspects 10-13, further comprising: providing data indicating a result of the MPLMN scan.

Aspect 15: A method of wireless communication performed by a UE, comprising: performing an MPLMN scan of a first set of frequency bands based at least in part on a user preference, the first set of frequency bands comprising one of: non-mmW frequency bands, or mmW frequency bands; providing data indicating a result of the MPLMN scan; and selectively continuing the MPLMN scan, for a second set of frequency bands, based at least in part on one of: the user preference, or user input associated with the result of the MPLMN scan.

Aspect 16: The method of Aspect 15, wherein the first set of frequency bands comprises the non-mmW frequency bands, and the second set of frequency bands comprises the mmW frequency bands.

Aspect 17: The method of Aspect 15, wherein the first set of frequency bands comprises the mmW frequency bands, and the second set of frequency bands comprises the non-mmW frequency bands.

Aspect 18: The method of Aspect 15, wherein the first set of frequency bands comprises the non-mmW frequency bands based at least in part on the user preference specifying no preference.

Aspect 19: The method of any of Aspects 15-18, wherein the non-mmW frequency bands include sub-6 GHz frequency bands.

Aspect 20: The method of any of Aspects 15-19, further comprising: performing an acquisition database scan prior to performing the MPLMN scan, the acquisition database scan comprising a scan of historical cells associated with a location of the UE.

Aspect 21: An apparatus for wireless communication at a device, comprising a processor; memory coupled with the processor; and instructions stored in the memory and executable by the processor to cause the apparatus to perform the method of one or more of Aspects 1-5.

Aspect 21: An apparatus for wireless communication at a device, comprising a processor; memory coupled with the processor; and instructions stored in the memory and executable by the processor to cause the apparatus to perform the method of one or more of Aspects 6-9.

Aspect 21: An apparatus for wireless communication at a device, comprising a processor; memory coupled with the processor; and instructions stored in the memory and executable by the processor to cause the apparatus to perform the method of one or more of Aspects 10-14.

Aspect 21: An apparatus for wireless communication at a device, comprising a processor; memory coupled with the processor; and instructions stored in the memory and executable by the processor to cause the apparatus to perform the method of one or more of Aspects 15-20.

Aspect 22: A device for wireless communication, comprising a memory and one or more processors coupled to the memory, the one or more processors configured to perform the method of one or more of Aspects 1-5.

Aspect 23: A device for wireless communication, comprising a memory and one or more processors coupled to the memory, the one or more processors configured to perform the method of one or more of Aspects 6-9.

Aspect 24: A device for wireless communication, comprising a memory and one or more processors coupled to the memory, the one or more processors configured to perform the method of one or more of Aspects 10-14.

Aspect 25: A device for wireless communication, comprising a memory and one or more processors coupled to the memory, the one or more processors configured to perform the method of one or more of Aspects 15-20.

Aspect 26: An apparatus for wireless communication, comprising at least one means for performing the method of one or more of Aspects 1-5.

Aspect 27: An apparatus for wireless communication, comprising at least one means for performing the method of one or more of Aspects 6-9.

Aspect 28: An apparatus for wireless communication, comprising at least one means for performing the method of one or more of Aspects 10-14.

Aspect 29: An apparatus for wireless communication, comprising at least one means for performing the method of one or more of Aspects 15-20.

Aspect 30: A non-transitory computer-readable medium storing code for wireless communication, the code comprising instructions executable by a processor to perform the method of one or more of Aspects 1-5.

Aspect 31: A non-transitory computer-readable medium storing code for wireless communication, the code comprising instructions executable by a processor to perform the method of one or more of Aspects 6-9.

Aspect 32: A non-transitory computer-readable medium storing code for wireless communication, the code comprising instructions executable by a processor to perform the method of one or more of Aspects 10-14.

Aspect 33: A non-transitory computer-readable medium storing code for wireless communication, the code comprising instructions executable by a processor to perform the method of one or more of Aspects 15-20.

Aspect 34: A non-transitory computer-readable medium storing a set of instructions for wireless communication, the set of instructions comprising one or more instructions that, when executed by one or more processors of a device, cause the device to perform the method of one or more of Aspects 1-5.

Aspect 35: A non-transitory computer-readable medium storing a set of instructions for wireless communication, the set of instructions comprising one or more instructions that, when executed by one or more processors of a device, cause the device to perform the method of one or more of Aspects 6-9.

Aspect 36: A non-transitory computer-readable medium storing a set of instructions for wireless communication, the set of instructions comprising one or more instructions that, when executed by one or more processors of a device, cause the device to perform the method of one or more of Aspects 10-14.

Aspect 37: A non-transitory computer-readable medium storing a set of instructions for wireless communication, the set of instructions comprising one or more instructions that, when executed by one or more processors of a device, cause the device to perform the method of one or more of Aspects 15-20.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors, coupled to the memory, configured to:
determine at least one of:
the UE is not camped on a millimeter wave (mmW) cell and no neighboring cells are mmW cells, or
the UE is operating in a mobility state;
forgo, based on the determination, a manual public land mobile network (MPLMN) scan of mmW frequency bands; and
perform, based on the determination, an MPLMN scan of only non-mmW frequency bands for non-mmW cells.

2. The UE of claim 1, wherein the non-mmW frequency bands include sub-6 GHz frequency bands.

3. The UE of claim 1, wherein the mobility state is associated with the UE moving at a speed that satisfies a speed threshold.

4. The UE of claim 1, wherein the one or more processors are further configured to:
perform an acquisition database scan prior to performing the MPLMN scan, the acquisition database scan comprising a scan of historical cells associated with a location of the UE.

5. The UE of claim 1, wherein the one or more processors are further configured to:
provide data indicating a result of the MPLMN scan.

6. A user equipment (UE) for wireless communication, comprising:
a memory; and
one or more processors, coupled to the memory, configured to:
perform a manual public land mobile network (MPLMN) scan of non-millimeter wave (mmW) frequency bands for non-mmW cells;
determine, based at least in part on performing the MPLMN scan, that no non-mmW cells were identified by the MPLMN scan; and
forgo a second MPLMN scan of mmW frequency bands for mmW cells based at least in part on the determination.

7. The UE of claim 6, wherein the non-mmW frequency bands include sub-6 GHz frequency bands.

8. The UE of claim 6, wherein the one or more processors are further configured to:
perform an acquisition database scan prior to performing the MPLMN scan, the acquisition database scan comprising a scan of historical cells associated with a location of the UE.

9. The UE of claim 6, wherein the one or more processors are further configured to:
provide data indicating a result of the MPLMN scan.

10. A user equipment (UE) for wireless communication, comprising:
a memory; and
one or more processors, coupled to the memory, configured to:
perform a manual public land mobile network (MPLMN) scan of non-millimeter wave (mmW) frequency bands for non-mmW cells;
identify, based at least in part on performing the MPLMN scan, at least one non-mmW cell; and
continue the MPLMN scan for one or more mmW cells that correspond to the at least one non-mmW cell.

11. The UE of claim 10, wherein the non-mmW frequency bands include sub-6 GHz frequency bands.

12. The UE of claim 10, wherein the one or more processors are further configured to:
perform an acquisition database scan prior to performing the MPLMN scan, the acquisition database scan comprising a scan of historical cells associated with a location of the UE.

13. The UE of claim 10, wherein the one or more mmW cells correspond to the at least one non-mmW cell by being geographically co-located with the at least one non-mmW cell.

14. The UE of claim 10, wherein the one or more processors are further configured to:
provide data indicating a result of the MPLMN scan.

15. A user equipment (UE) for wireless communication, comprising:
a memory; and
one or more processors, coupled to the memory, configured to:
perform a manual public land mobile network (MPLMN) scan of a first set of frequency bands based at least in part on a user preference, the first set of frequency bands comprising one of:
non-millimeter wave (mmW) frequency bands, or
mmW frequency bands;
provide data indicating a result of the MPLMN scan; and
selectively continue the MPLMN scan, for a second set of frequency bands, based at least in part on one of:
the user preference, or
user input associated with the result of the MPLMN scan.

16. The UE of claim 15, wherein the first set of frequency bands comprises the non-mmW frequency bands, and the second set of frequency bands comprises the mmW frequency bands.

17. The UE of claim 15, wherein the first set of frequency bands comprises the mmW frequency bands, and the second set of frequency bands comprises the non-mmW frequency bands.

18. The UE of claim 15, wherein the first set of frequency bands comprises the non-mmW frequency bands based at least in part on the user preference specifying no preference.

19. The UE of claim 15, wherein the non-mmW frequency bands include sub-6 GHz frequency bands.

20. The UE of claim 15, wherein the one or more processors are further configured to:
perform an acquisition database scan prior to performing the MPLMN scan, the acquisition database scan comprising a scan of historical cells associated with a location of the UE.
